(19) United States
(12) Patent Application Publication
(10) Pub. No.: US 2026/0316860 A1
(43) Pub. Date: Oct. 15, 2026

(54) SNOWMOBILE TRACTION STUD

(71) Applicant: INTERNATIONAL ENGINEERING & MANUFACTURING INC, Hope, MI (US)

(72) Inventor: Eric J. Troyer, Midland, MI (US)

(21) Appl. No.: 19/639,862

(22) Filed: Apr. 6, 2026

Related U.S. Application Data
(60) Provisional application No. 63/786,148, filed on Apr. 9, 2025.

(51) Int. Cl. B62D 55/26; B62D 55/24; B62M 27/02

(52) U.S. Cl. CPC B62D 55/26; B62D 55/244; B62M 27/02; B62M 2027/027

(57) ABSTRACT

A chisel tooth style snowmobile traction stud for the track of a snowmobile has a head and a shank. The shank has a flat front face that defines the chisel tooth design. The shank has a threaded portion adapted to receive a nut. A mortise in the distal end of the shank receives a carbide insert that has a leading tip and is fixed in place by brazing compound. A bevel extends from the leading tip. The mortise has a planar front wall that is parallel to the front face of the shank. The carbide insert has a generally planar load-bearing face in contact with the front wall of the mortise. The mortise includes left and right side walls joining the front wall, each having a filleted shape. The distal end of the shank has a facet that is generally aligned with the bevel of the carbide insert.

### CROSS REFERENCE TO RELATED APPLICATIONS

This application claims priority to Provisional Patent Application 63/786,148 filed Apr. 9, 2025, the entire disclosure of which is hereby incorporated by reference and relied upon.

### BACKGROUND OF THE INVENTION

### Field of the Invention

The invention relates generally to snowmobile traction studs, and more particularly to a carbide tipped snowmobile traction stud.

### Description of Related Art

Snowmobiles are tracked vehicles specially adapted for traversing snow and ice-covered terrain. The track of a snowmobile is of the flexible endless-type, comprising a continuous band of tread configured to efficiently distribute the weight of the snowmobile. In some applications, it is desirable to fit the snowmobile track with metal spikes, known commonly as traction studs. Traction studs provide critical grip on ice and hard-packed snow.

Traction studs come in many different styles to suit the type of track used, intended riding style and ground conditions. The various styles are characterized by modifications to stud material, plating, tip design, retention scheme, shoulder design, etc. Two distinct styles of tip design include the carbide tip and the chisel tooth. Heretofore, the carbide tip has been expressed in the form of a pointed cylindrical pin like the sharpened end of a pencil or a nail set. Pointed carbide tips are well-known for their penetration efficiency and wear-resistance. As pointed carbide tips are not constrained to a specific forward-facing orientation, they are considered relatively easy to install and maintain. Examples of traction studs having a conventional pointed carbide tip may be found in U.S. Pat. No. 5,685,621 to Nugent, and U.S. Pat. No. 10,562,576 to Mussleman et al., U.S. Pat. No. 4,758,055 to Anderson, and U.S. Pat. No. 6,203,126 to Harguth.

The chisel tooth, on the other hand, employs a flat wedge-shaped configuration reminiscent of a carpenter's chisel. A chisel tooth tip design acts like a flat surface scooper, grabbing the terrain and moving a substantial amount of surface area. Chisel tooth tip designs are often favored by those competing in ice/snow/grass drag races. All chisel tooth tip style traction studs must be carefully installed and maintained with a rearward-facing orientation. Examples of traction studs having a conventional chisel tooth tip design may be found in U.S. Pat. No. 5,641,214 to Kafka, and U.S. Pat. No. 5,980,001 to Rubel.

The prior art has evidenced some attempts to combine the chisel tooth tip design with a carbide tip, however these have been largely unsuccessful. Prior art style chisel tooth studs with a pin-shaped carbide insert tend to quickly wear on the front face into a rounded shape corresponding to the shape of the carbide insert. When the flat front face of the driving portion disappears, the prior art traction studs no longer provide the advantages of a chisel tooth tip stud and must be replaced.

There is therefore a need in the art for an improved traction stud that retains the performance advantages of a chisel tooth tip design over longer periods of time than can be achieved using conventional methods.

### BRIEF SUMMARY OF THE INVENTION

The present invention is a snowmobile traction stud of the type affixed to a flexible endless track of a snowmobile propulsion system. According to one aspect of the invention, the traction stud comprises a head. A shank extends axially from the head to a distal end. The shank has a driving portion adjacent the distal end. The driving portion has a front face and a rear face. The front face is generally flat. A mortise is disposed in the distal end of the shank. The mortise extends axially in the shank to a mortise bottom. The mortise has a particular cross-sectional mortise shape taken perpendicular to the axial direction. A carbide insert is disposed in the mortise and supported by the mortise bottom. The carbide insert has a cross-sectional insert shape that mates with the cross-sectional mortise shape enabling the carbide insert to be received axially into the mortise. The carbide insert has an exposed portion that extends above the mortise, away from the distal end of the shank. The mortise has a generally planar front wall that is spaced parallel from the front face of the driving portion. And, the carbide insert has a generally planar load-bearing face that is in contact with the front wall of the mortise.

The flat load-bearing face of the insert, in combination with the flat front wall of the mortise, enables several new and surprising results. When these flat surfaces are oriented perpendicular to the driving and reaction forces, by careful attention during the installation process, optimal conditions are created for managing the transfer of stresses generated during operation of a snowmobile. Also, a favorable wear pattern results from the flat load-bearing face of the insert in combination with the flat front wall of the mortise. Over time the softer metal of the front face wears from abrasion/attrition, meanwhile the durable carbide insert tends to maintain its shape. Consequently, the front face of the driving portion eventually conforms to the shape of the carbide insert, including its flat load-bearing face. A significant section of the front face of the driving portion is advantageously preserved because the carbide insert has a flat load-bearing face. For at least these several reasons, the flat load-bearing face of the insert in combination with the flat front wall of the mortise is a novel attribute of the present invention enabling significantly improved durability and service life.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is an exemplary depiction of a snowmobile;

FIG. 2 is a perspective view of a fragmentary portion of a snowmobile track taken generally from the area circumscribed at 2 in FIG. 1;

FIG. 3 is a fragmentary side view of the snowmobile track taken generally from the area circumscribed at 3 in FIG. 1 and illustrated in engagement with an underlying terrain;

FIG. 4 is an enlarged view of a traction stud according to an embodiment of the invention, as taken generally from the area circumscribed at 4 in FIG. 3;

FIG. 5 is a view of the traction stud taken generally along lines 5-5 of FIG. 3;

FIG. 6 is a cross-sectional view taken generally along lines 6-6 of FIG. 5;

FIG. 7 is an exploded view of a traction stud according to an embodiment of the invention;

FIG. 8 is a front elevation view of a carbide insert according to an embodiment of the invention;

FIG. 9 is a side elevation view of the carbide insert of FIG. 8;

FIG. 10 is a top view of the carbide insert of FIG. 8;

FIG. 11 is an enlarged end view of the traction stud showing force vectors bearing upon the flat front face of the shank;

FIG. 11A is a view as in FIG. 11 showing the shank of the traction stud abraded through use over time but still retaining a flat portion of the flat front face;

FIG. 12 is a view as in FIG. 11 showing certain exemplary dimensional relationships of the carbide insert relative to the diameter of the shank;

FIG. 13 is an enlarged view of the traction stud as in FIG. 4, with force vectors added to describe certain mechanical properties;

FIG. 14 is an exemplary flow chart describing a method for manufacturing a traction stud according to an embodiment of the invention;

FIG. 15 is a rear elevation view of a traction stud according to a first alternative embodiment of the present invention;

FIG. 16 is a side elevation view of the traction stud shown in FIG. 15;

FIG. 17 is an exploded perspective view of the traction stud of FIG. 15;

FIG. 18 is a rear elevation view of a traction stud according to a second alternative embodiment of the present invention;

FIG. 19 is a side elevation view of the traction stud of FIG. 18;

FIG. 20 is a top view of the traction stud of FIG. 18;

FIG. 21 is a perspective view of the traction stud of FIG. 18;

FIG. 22 is a rear elevation view of a traction stud according to a third alternative embodiment of the present invention;

FIG. 23 is a side elevation view of the traction stud of FIG. 22;

FIG. 24 is a top view of the traction stud of FIG. 22; and

FIG. 25 is a perspective view of the traction stud of FIG. 22.

### DETAILED DESCRIPTION OF THE INVENTION

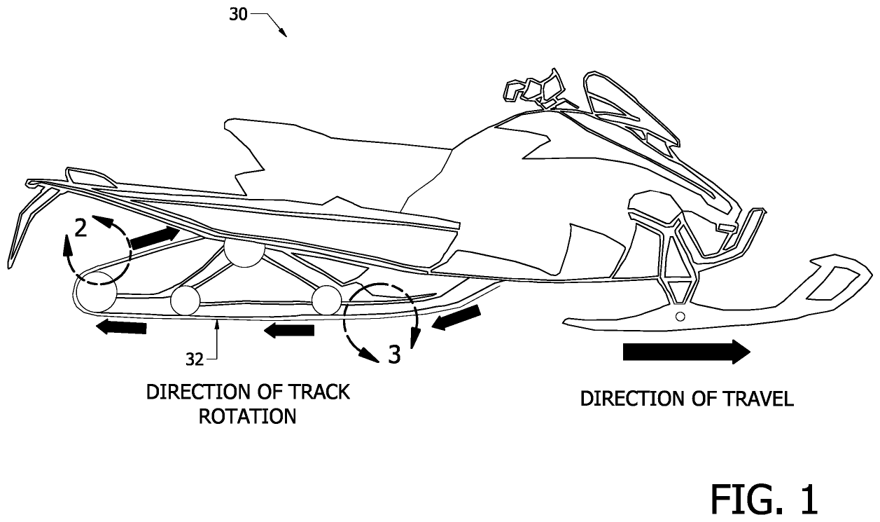

Referring to the figures, wherein like numerals indicate like or corresponding parts throughout the several views, an exemplary snowmobile is generally shown at 30 in FIG. 1. The snowmobile 30 can be of any suitable type configured for travel on snow and/or ice covered terrain. The modern snowmobile 30 is a complex machine that typically comprises several primary systems, including for example steering/control, suspension and chassis, comfort and propulsion.

Of particular relevance to this invention is the propulsion system of the snowmobile 30. In addition to having an engine or motor and a transmission system (not visible in FIG. 1), the propulsion system includes a flexible endless-type track 32. The track 32 is a continuous band of tread presenting a relatively large ground contact area over which to distribute the weight of the snowmobile 30. The track 32 can be fabricated from any suitable material, including but not limited to a reinforced rubber composition. In some cases, the track 32 may be of the single-ply type, whereas in other case of the two-ply type. The track 32 has an interior surface and an exterior surface. The interior surface of the track 32 is constrained to a circulating motion by a suspension and drive system, which can include such features as idler wheels, sprockets and slide rails. The downwardly-facing portion of the exterior surface of the track 32 is adapted to make direct contact with the ground surface underneath the snowmobile 30, similar in function to the continuous track used in tracked vehicles such as bulldozers and military tanks.

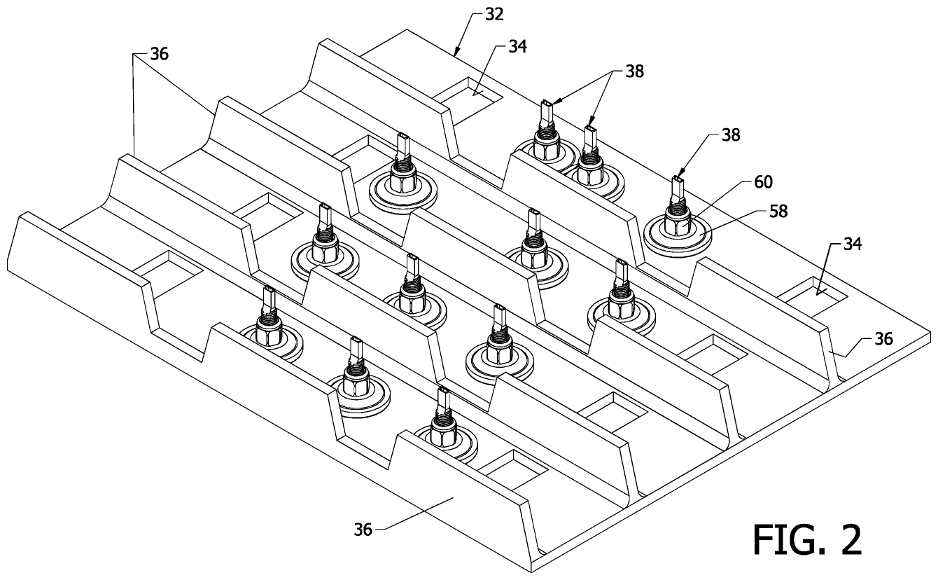

The track 32 has a generally constant width. In most modern snowmobiles 30, the track 32 will have at least one row of sprocket holes 34 configured to mesh with a sprocket driven by the engine or motor through a transmission. In the example of FIG. 2, the track 32 is shown having two rows of sprocket holes 34 configured to mesh with twin sprockets. Many variations are possible.

The exterior surface of the track 32 is typically fitted with an array of paddle-like ribs or lugs 36. Each lug 36 extends generally perpendicular outwardly from the exterior surface of the track 32 to provide enhanced traction on loose and/or slippery surfaces. Each lug 36 has a height measured perpendicularly from the exterior surface of the track 32. Each lug 36 is spaced apart from the next adjacent lug 36 by a lug spacing. That is to say, the lug spacing (also known as track pitch) is the longitudinal span of the valley, or distance between, adjacent lugs 36. The lug spacing is typically constant, although in some situations the lugs 36 may be unequally spaced apart from one another thus producing a non-regular lug spacing about the perimeter of the track 32. Common lug spacings include 2.86″, 2.52″ and 3.00″ but others are certainly possible.

The snowmobile track 32 may be fitted with an array of traction studs 38 to improve grip on ice and hard-packed snow. Each traction stud 38 is disposed in a respective stud mounting hole 40 (FIG. 6) of the track 32. The stud mounting holes 40 are strategically disbursed around the track 32 in the lug spacings between adjacent lugs 36. As can be appreciated from FIG. 2, each stud mounting hole 40 is generally equally spaced between the adjacent lugs 36, i.e., centered within the lug spacing region. Although many variations exist due to the construction of the track 32, the stud mounting hole 40 shown in the cross-sectional view of FIG. 6 has a countersink 42 in the interior surface. The countersink 42 is typically an elastic deformation of the track 32 resulting from installation of the stud 38, as will be explained. That is to say, there is an inset area surrounding the stud mounting hole 40 when the stud 38 is installed for use. And in a complementary manner, a bulge 44 on the exterior surface surrounds the stud mounting hole 40 and directly opposite the countersink 42. Like the countersink 42, the bulge 44 may also be the result of an elastic deformation of the track 32. Other track types and/or stud types may dictate stud mounting holes 40 with different configurations than that shown in FIG. 6.

As just mentioned, studs 38 can be affixed to the track 32 according to several different schemes. Two common fixation schemes are known as push-through and T-nut. The traction stud 38 depicted throughout the figures is of the push-through type having a large, flange-like head 46. The invention nevertheless contemplates studs 38 configured for T-nut applications, in which case the head 46 would typically be a threaded end. That is to say, the invention is not limited to any one particular stud fixation method, applying equally to push-through styles and T-nut configurations, and others.

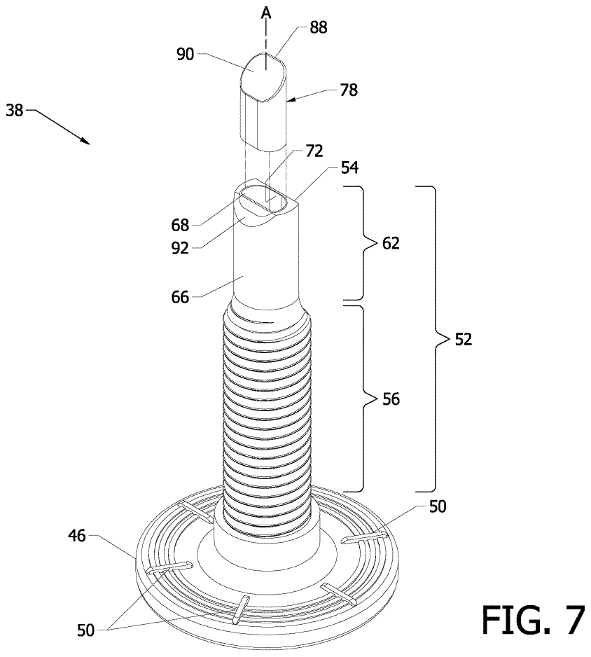

As can be seen from FIG. 6, the countersink 42 enables the head 46 to be recessed below the interior surface of the track 32, which facilitates movement traversing the suspension and drive system features. The head 46 may be designed with an integral tool-engaging feature. It being understood that studs 38 configured for T-nut applications typically would not have a tool-engaging feature. The example of FIG. 6 depicts the tool-engaging feature in the form of a hex or torx socket 48, however other options are certainly possible including screwdriver slots and wrench flats to name a few. As can be seen in FIG. 7, the head 46 may be formed with a plurality of anti-rotation ribs 50 configured to engage the interior surface of the track 32. The anti-rotation ribs 50 bite gently into the countersink 42 to resist twisting of the stud 38 once it has been fixed in an operative position on the track 32.

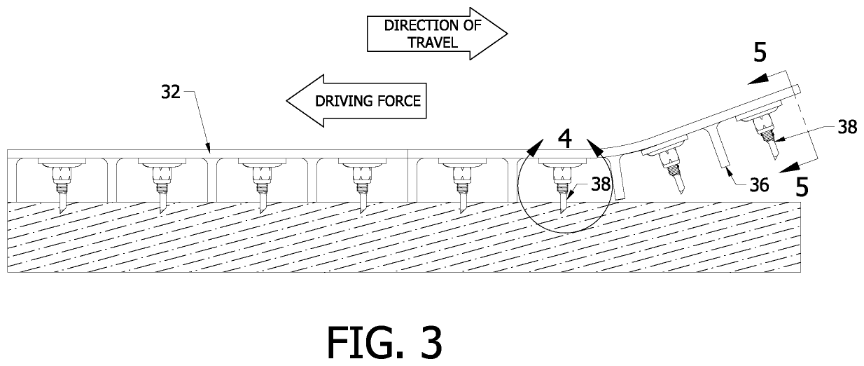

Each traction stud 38 has an elongated shank 52 that extends from the head 46 to a distal end 54. The elongated length of the shank 52 defines an axial direction for the stud 38, which is typically designed so that the distal end 54 stands proud of the lugs 36 as can be observed in FIG. 3. The shank 52 has a threaded portion 56 adjacent the head 46. In the push-through configuration of the stud 38 shown in FIG. 6, a washer 58 can be seen on the threaded portion 56 of the shank 52. The exemplary washer 58 is annular, but non-annular washer shapes are possible. The washer 58 is cupped to enable elastic deformation of the track 32 which results in formation of the bulge 44 on the exterior surface of the track 32. In this manner, the dished profile of the washer 58 is responsible for allowing the head 46 to pull the track 32 into the aforementioned countersink 42, thus enabling the head 46 to be recessed.

A fastener 60 is operatively engaged with the shank 52. The fastener 60 may comprise any suitable device, but in the illustrated examples appears in the form of a nut threaded onto the threaded portion 56 of the shank 52. The nut 60 is tightened so as to concurrently compress the washer 58 against the exterior surface of the track 32 and the head 46 against the interior surface of the track 32. The head 46 is recessed as the nut 60 is tightened, thus forming the countersink 42 and bulge 44 features. The nut 60 may be of the self-locking type having an integral nylon insert. Alternatively, or in addition, other anti-loosening devices can be employed to prevent unwanted unthreading of the nut 60, such as split washers, star washers, adhesives, and the like.

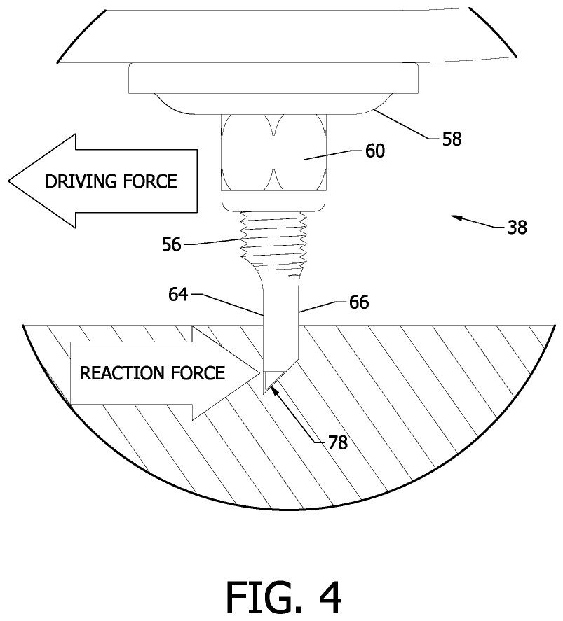

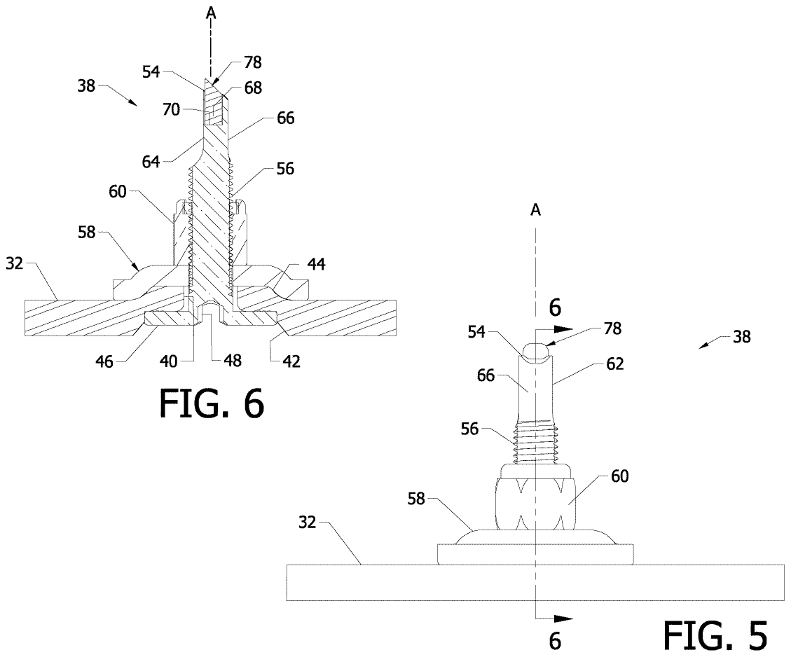

The stud shank 52 has a driving portion 62 adjacent the distal end 54. The driving portion 62 is the most outwardly extended section of the stud 38 configured to engage directly with the terrain, as shown in FIGS. 3 and 4. The axial length of the driving portion 62, relative to that of the threaded portion 56, is designed so that the driving portion 62 alone will penetrate into the terrain during the majority of anticipated operating conditions. See FIG. 3. In the illustrated embodiments, the shank 52 begins as a fully threaded member which, during the fabrication process, is subsequently milled or ground to form the driving portion 62. In this manner, it can be observed that the driving portion 62 is inset from the threads of the threaded portion 56. As part of that milling or grinding operation, the driving portion 62 is formed with a front face 64 and a rear face 66. The front face 64 is predominantly flat, or planar, as characteristic of chisel-point style studs. A generous scalloped region can be observed at the interface of the front face 64 and threaded portion 56 which provides a gentle transition for stress-strain management purposes. In the embodiment of FIGS. 2-13 the rear face 66 is semicircular giving the driving portion 62 a somewhat D-shaped cross-section as apparent from FIGS. 7, 11 and 12.

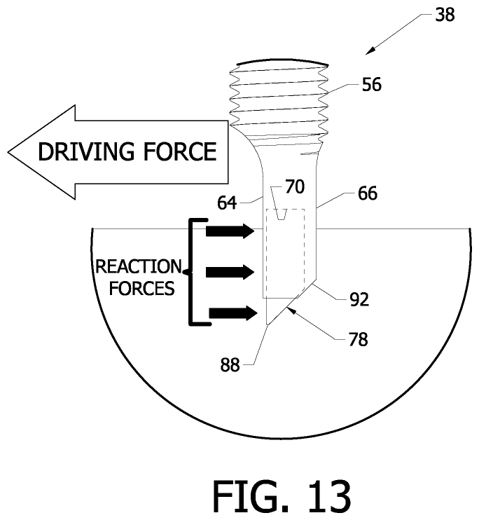

Installation of the stud 38 to the track 32 requires orientation of the front face 64 in a rearwardly facing direction substantially perpendicular to the driving direction. As shown in FIG. 13, the stud 38 is designed so that the driving force imparted through forward motion of the snowmobile 30 is met squarely by the reaction forces in the terrain. The relatively large flat front face 64 of each stud 38 thus acts something like a paddle in water which, together with the lugs 36, propels the snowmobile 30 forward with maximum efficiency (i.e., minimal slippage).

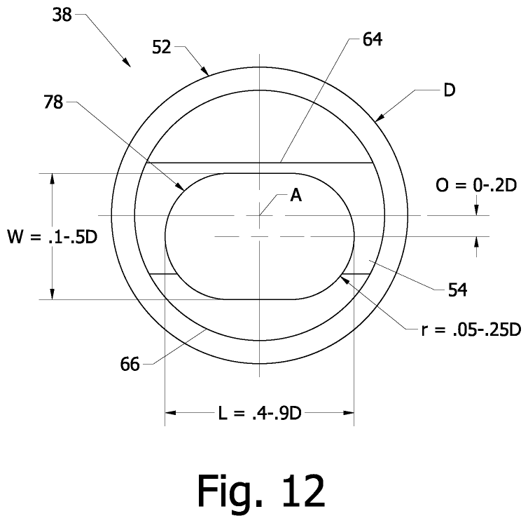

The width of the front face 64 is slightly less than the maximum width of the D-shaped driving portion 62. Acceptable results have been found when the width of the front face 64 is between about 75% and 99% of the maximum width of the D-shaped driving portion 62. This relationship can be observed in the end view of FIG. 12, where the maximum width of the D-shaped driving portion 62 is measured horizontally through the centerline A of the shank 52. In this view, the front face 64 appears as a horizontal line offset above the centerline A of the shank 52. The rear face 66 is also clearly seen in this view as a generally semi-cylindrical feature, thus together with the front face 64 forming a generally D-shape.

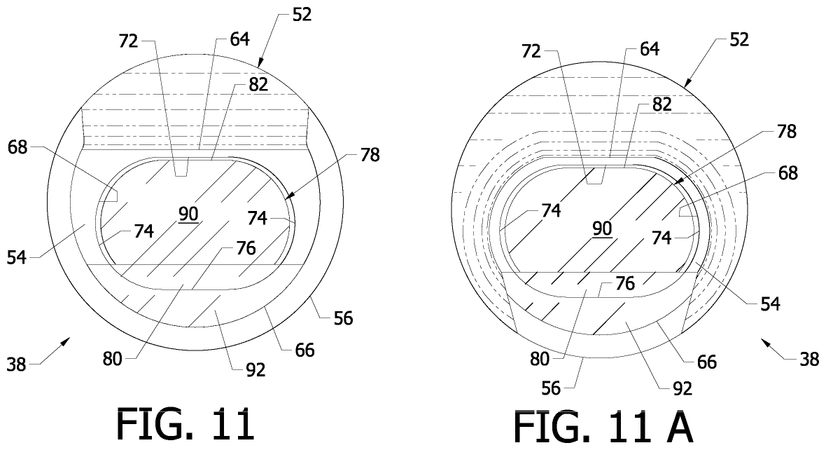

Turning now to FIGS. 6 and 7, a mortise 68 is disposed in the distal end 54 of the shank 52. The mortise 68 extends axially along the shank 52 to a mortise bottom 70. The mortise 68 has a cross-sectional mortise shape as taken perpendicular to the axial direction, which can best be appreciated from the end views of FIGS. 11 and 12. The axial distance between the distal end 54 and the mortise bottom 70 comprises a mortise depth. FIGS. 6 and 13 provide the best viewing perspective on the mortise depth. In these examples, the mortise depth is approximately half the axial length of the driving portion 62. That is to say, the mortise bottom 70 is stationed approximately halfway between the distal end 54 and the interface of the front face 64 and threaded portion 56. The mortise 68 has a generally planar front wall 72 spaced parallel from the front face 64 of the driving portion 62. In practice, the space between the front wall 72 and the front face 64 is relatively small. In this manner, the mortise 68 can be optimally located within the driving portion 62. The mortise 68 has left and right side walls 74 joining the front wall 72. The left and right side walls 74 each have a filleted shape where they adjoin the front wall 72. That is to say, there is an internal rounded corner at the intersection of front wall 72 with each of the left and right side walls 74. The mortise 68 also has a rear wall 76 joining the side walls 74. In the illustrated examples the rear wall 76 is generally planar and spaced parallel from the front wall 72. However in other contemplated embodiments the rear wall 76 could be semi-circular, or triangular, or any other suitable shape.

A carbide insert 78 is disposed in the mortise 68, supported against the mortise bottom 70 either directly or indirectly. The carbide insert 78 has an exposed portion that extends proudly above the mortise 68, away from the distal end 54 of the shank 52. The carbide insert 78 has a cross-sectional insert shape that is configured to mate with the cross-sectional mortise shape, thus enabling the carbide insert 78 to be received axially into the mortise 68. In some applications, a clearance fit is indicated, whereas in other applications a force fit or interference fit or shrink fit might be preferred. When a clearance fit is indicated, the carbide insert 78 is secured in the mortise 68 with braze 80 or by some other binding agent, adhesive or mechanical connection. In several views, the braze 80 can be seen as a thin film between the carbide insert 78 and the mortise 68 which serves to fixedly adjoin the carbide insert 78 within the mortise 68.

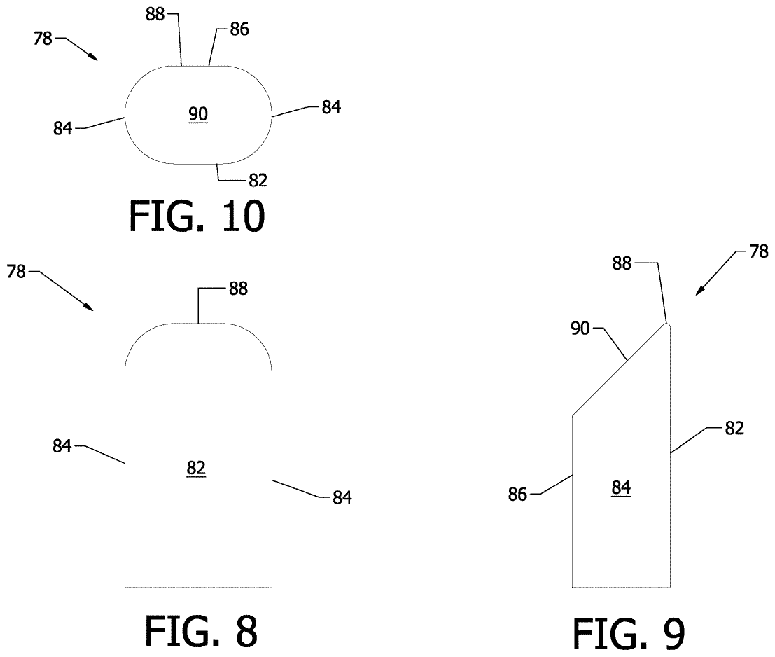

FIGS. 8-10 show the carbide insert 78 from front, side and top views respectively. All three perspectives show the carbide insert 78 having a generally planar load-bearing face 82. The load-bearing face 82 opposes the front wall 72 of the mortise 68 so that forces are transferred therebetween, either directly in surface-to-surface contact or indirectly through a braze compound 80 or other intervening binder. The insert 78 has left and right sides 84 shaped to correspond with the left and right side walls 74 of the mortise 68. It can therefore be appreciated that the left and right sides 84 each have a rounded shape where they adjoin the load-bearing face 82. A backside 86 adjoins the left and right sides 84. The back side 86 is shaped according to the rear wall 76 of the mortise 68. Thus, in the illustrated examples where the rear wall 76 is generally planar, the backside 86 is likewise generally planar.

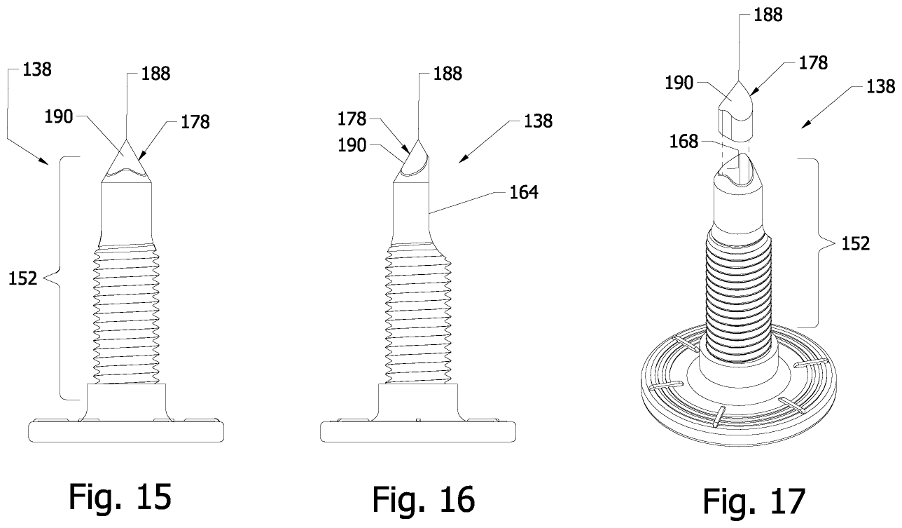

The exposed portion of the carbide insert 78 has a leading tip 88. The leading tip 88 is designed for efficient penetration into hard terrain surfaces, such as packed snow and/or ice. In the embodiments shown in FIGS. 2-13 and 18-25, the leading tip 88 is configured as an edge, something like the blade of a carpenter's chisel. In the alternative embodiment of FIGS. 15-17, the leading tip 188 is formed as a conical point. It will be appreciated that variations in the shape of the leading tip 88 are possible within the scope of this invention.

Returning again to the embodiment of FIGS. 2-13 in which the leading tip 88 is configured somewhat like a carpenter's chisel, the edge of the leading tip 88 lies along the load-bearing face 82 of the carbide insert 78. This is accomplished by forming a bevel 90 on the exposed portion of the carbide insert 78 that extends from the leading tip 88 and is pitched away from the load-bearing face 82. That is, the bevel 90 slopes rearwardly, away from the front face 64 of the stud shank 52, and in a direction toward the rear face 66 of the driving portion 62. The included angle between the front face 64 and bevel 90 comprises a bevel angle. Bevel angles of about 30-60 degrees are possible. Smaller bevel angles provide better penetration but are more fragile. And conversely, larger bevel angles are more durable. In the illustrated examples, the bevel angle is shown to be about 45 degrees, which has been found to provide a satisfactory balance of penetration and durability characteristics. The bevel 90 is shown in FIGS. 2-13 as being generally planar, but could also be concave (hollow ground) or convex, or formed in some other non-planar shape. For example, the alternative embodiment of FIGS. 15-17 portrays the bevel 190 as being generally conical.

The distal end 54 of the driving portion 62 of the shank 52 may be formed with a facet 92. This will be especially advantageous in situations where the bevel 90 overlaps with the mortise 68. In such cases, the facet 92 helps conform, or generally conform, the distal end 54 with the bevel 90 of the carbide insert 78. In practice, the carbide insert 78 may be pre-formed to its final shape such as by a powdered metal/sintering process or using any other suitable technique. The facet 92 may then be formed in a machining or grinding operation after the carbide insert 78 has been fixed in the mortise 68. According to this optional sequence where the facet 92 is created after the insert 78 has been fixed in the mortise 68, it will be appreciated that any binder agent, such as braze compound 80, may have puddled inside the mortise 68 against the bevel 90. And as a consequence, when the facet 92 is subsequently formed as by machining or grinding, the binder agent will be exposed and appear co-planar with the facet 92 as perhaps best observed in FIG. 11.

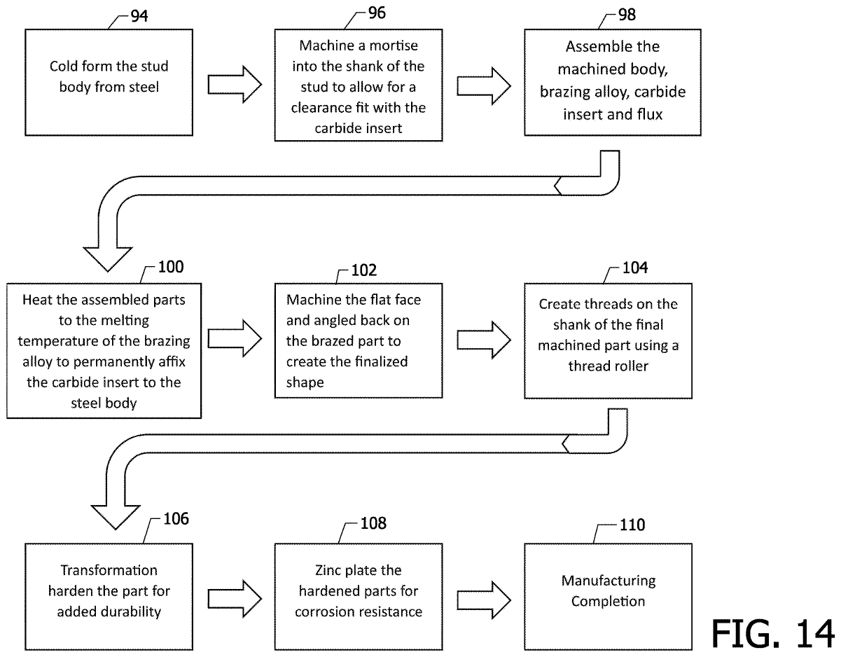

FIG. 12 is a view as in FIG. 11 showing certain exemplary dimensional relationships of the carbide insert 78 relative to the shank 52. In this example, the shank diameter D represents the major diameter of the shank 52, excluding the head 46. The shank diameter D corresponds to the diameter of the threaded portion 56, which is the major diameter of the thread forms (i.e., crest diameter). As will be described subsequently in connection with FIG. 14, the shank diameter D may be set at the time of cold forming the stud body at function block 94. The centerline A is the centerline of the shank diameter D. In the end view of FIG. 12, the carbide insert 78 is shown having a length L and a width W. The length L measure is oriented parallel to the front face 64, whereas the width W measure is oriented perpendicular to the front face. In this exemplary embodiment and in this end view, the carbide insert 78 has an oval shape. Acceptable results have been achieved when the carbide insert 78 is dimensioned so that its length L is between 0.4 and 0.9 times the shank diameter D, and so that its width W is between 0.1 and 0.5 times the shank diameter D. Because the carbide insert 78 in this example has an oval shape, the radius r of its left and right sides 84 can be understood as being equal to half the width W, i.e., r=½W. Thus, the radius r of the sides 84 of the carbide insert 78 can be equated to the shank diameter D according to the formula: r=(0.05−0.25)*D. Also, the offset O of the long or major centerline of the carbide insert 78, i.e., the centerline that is parallel to front face 64, is between 0.0 and 0.2 times the shank diameter D.

Turning now to FIGS. 4, 11A and 13, the functionality and advantages of the present invention will be described in greater detail. During forward travel of the snowmobile 30, the track 32 is driven, like the tread of a treadmill, in a circuit around the suspension system. The traction studs 38 are individually plunged into the terrain like claws or cleats as they traverse the bottom section of the track 32. The driving force exerted through the individual traction studs 38 pushes against the terrain, which could be hard packed snow or ice. As is universally understood from Newton's Third Law of Motion, every force exerted by one object on another encounters a simultaneous reaction force that is equal in magnitude and opposite in direction. Thus, the driving force exerted by each individual traction stud 38 is opposed by a resistance force in the terrain of equal magnitude, as diagrammed in FIGS. 4 and 13.

Considering these physics, it will be appreciated that the flat load-bearing face 82 of the insert 78 in combination with the flat front wall 72 of the mortise 68, both being oriented perpendicular to the driving and reaction forces, create an optimal condition for managing the transfer of stresses generated during operation of the snowmobile 30. These stresses are further facilitated and managed by the radiused sides 84 in combination with the filleted side walls 74. The rounded joints avoid stress concentrations and thereby reduce the likelihood of stress-induced fractures in the components and/or in the braze joint 80.

Perhaps even more importantly than stress management, however, is the favorable wear pattern resulting from the flat load-bearing face 82 of the insert 78 in combination with the flat front wall 72 of the mortise 68. As previously mentioned, prior art chisel tooth style traction studs are favored by competitive users because the chisel tooth tip design acts like a flat surface scooper, grabbing the terrain and moving a substantial amount of surface area. All types of traction studs are subject to wear and degradation over time. Traditional chisel tooth tip designs without a carbide insert typically wear down quickly necessitating replacement. Prior art style chisel tooth studs with a small pin-shaped carbide insert will tend to maintain their original length but quickly wear on the front face into a rounded shape corresponding to the shape of the carbide insert. Thus, the softer metal on the front face of a prior art chisel tooth stud will wear quickly around the pin-shaped carbide insert, leaving a rounded shape that compromises the flat surface scooper favored by competition users. The flat front face of the driving portion completely disappears, no longer providing the primary advantages of a chisel tooth tip stud.

A novel advantage of this present invention is the flat load-bearing face 82 of the insert 78. FIG. 11A portrays a typical wear pattern of the traction stud 38, to be compared with the fresh/new shape shown in FIG. 11. Over time the softer metal of the front face 64 wears from abrasion/attrition, meanwhile the durable carbide insert 78 tends to maintain its shape. Consequently, the front face 64 of the driving portion 62 eventually conforms to the shape of the carbide insert 78, including its flat load-bearing face 82. As illustrated in FIG. 11A, a significant section of the front face 64 of the driving portion 62 is preserved because the carbide insert 78 has a flat load-bearing face 82. It will also be observed that the radiused sides 84 of the insert 78 likewise provoke a rounded wear pattern in the softer metal of the driving portion 62, which as mentioned above facilitates and manages the stresses in the components even when subjected to harsh competitive driving conditions. For at least these several reasons, the flat load-bearing face 82 of the insert 78 in combination with the flat front wall 72 of the mortise 68 is a novel attribute of the present invention enabling significantly improved durability and service life.

An exemplary method for making the traction stud 38 is depicted graphically in FIG. 14. The process begins with function block 94 where the stud body is cold formed from a steel workpiece having a preform shank 52. In some cases the head 46 can be cold formed as an integral feature with the shank 52 as suggested in FIG. 6, or made as a loose-piece element that is screwed onto the threaded portion 56 later in the assembly process. Next, at function block 96, the mortise 68 is machined into the distal end 54 of the shank 52. The mortise 68 can be made using any suitable technique capable of producing a flat front wall 72, including but not limited to an end mill. It is desirable, although not required, that mortise 68 be formed with left and right sidewalls 74 that are filleted with respect to the flat front wall 72. Although function block 96 indicates that the mortise 68 is sized to accommodate a clearance fit with respect to the carbide insert 78, other fit classes are certainly possible, including force/interference fits and the like. The shape of the mortise 68 complements the shape of the carbide insert 78, such that both include opposing flat surfaces 72, 82 that are parallel to the flat front face 64.

In function block 98, the carbide insert 78 is inserted in the mortise 68 together with a brazing alloy 80 and flux material (or other suitable binding agent). The assembled parts are then heated in function block 100 to liquify the brazing alloy, thus securely fixing the insert 78 to the shank 52. When the parts have cooled sufficiently, the driving portion 62 of the preform shank can be machined to the D-shape shown in FIG. 11 (or other shape) characterized by a flat front face 64, as per function block 102. Facet 92 is also machined into the distal end 54 at this time.

In function block 104, threads 56 are created on the lower portion of the shank 52, such as by cutting or rolling or any other suitable thread-forming technique. Next, in function block 106, the assembly is hardened to a predefined specification for durability. Following which, the hardened parts may be zinc plated for corrosion resistance. See function block 108. Function block 110 represents completion of this exemplary manufacturing process. Those of skill in the art will envision possible variations in the manufacturing and/or assembly process.

FIGS. 15-17 illustrate an alternative embodiment of the traction stud 138. In this example, like or corresponding parts described previously are indicated with like reference numerals offset by 100. Of particular relevance in this embodiment is the leading tip 188 which is formed as a conical point rather than having an edge. Point of the leading tip 188 may be generally centered on the insert 178, or as shown offset slightly toward the front face 164 of the shank 152. A pointed leading tip 188 with conical bevel 190 may be preferred for ice or other hard terrain conditions that would benefit from enhanced penetration ability. Despite the conical shape of the exposed portion of the insert 178, the mortise 168 and insert 178 nevertheless maintain the flat load-bearing interfaces that are parallel to the flat front face 164, thus preserving the novel benefits of the present invention.

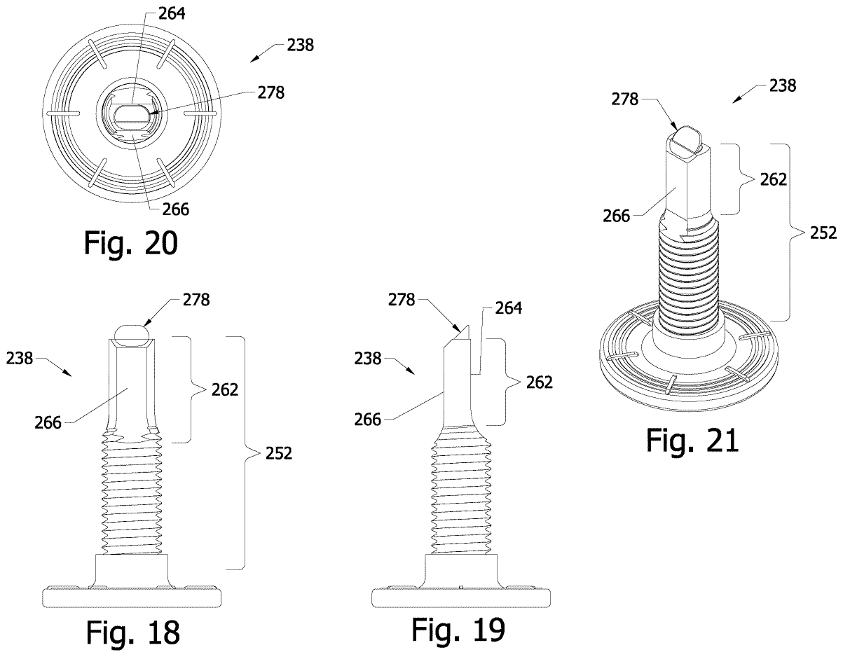

FIGS. 18-21 illustrate another alternative embodiment of the traction stud 238. In this example, like or corresponding parts described previously are indicated with like reference numerals offset by 200. Of particular relevance in this embodiment is that the driving portion 262 of the shank 252 is formed for enhanced penetration ability rather than changing the configuration of the leading tip. In this embodiment, the rear face 266 of the driving portion 262 is modified so as to have a single flat relief that is parallel to the front face 264. As a result, the driving portion 262 no longer possesses a D-shape as in the preceding embodiments, but rather an almost rectangular shape. The relief cut into the rear face 266 yields a more streamlined profile that is better able to penetrate hard surfaces like ice. In all other respects, the traction stud 238 will perform substantially similar to those embodiments described above. And importantly, the mortise and insert 278 nevertheless maintain the flat load-bearing interfaces that are parallel to the flat front face 264, thus preserving the novel benefits of the present invention.

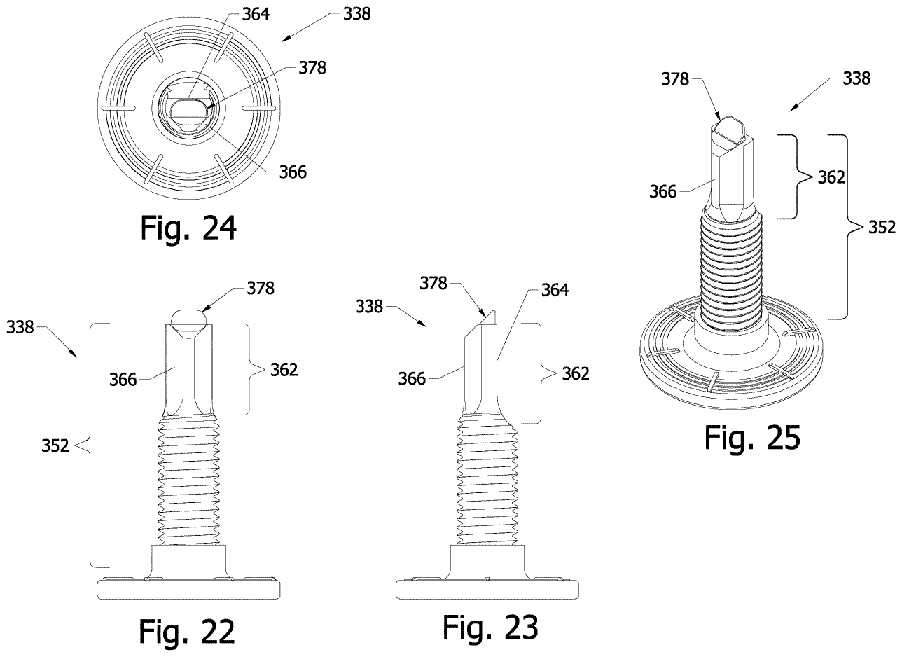

FIGS. 22-25 illustrate a still further alternative embodiment of the traction stud 338. In this example, like or corresponding parts described previously are indicated with like reference numerals offset by 300. As in the preceding embodiment, the driving portion 362 of the shank 352 is formed for enhanced penetration ability. In this embodiment, the rear face 366 of the driving portion 362 is modified so as to have two angled reliefs. As a result, the driving portion 362 has something of an irregular pentagon shape reminiscent of the home plate in baseball. The two angled reliefs cut into the rear face 366 yield a streamlined profile that efficiently penetrates hard terrain. In all other respects, the traction stud 338 will perform substantially similar to those embodiments described above. And, as characteristic of all disclosed embodiments, the mortise and insert 378 maintain flat load-bearing interfaces that are parallel to the flat front face 364, thus preserving the novel benefits of the present invention.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A snowmobile traction stud of the type affixed to a flexible endless track of a snowmobile propulsion system, said traction stud comprising:
a head,
a shank extending from said head to a distal end and defining there along an axial direction,
said shank having a driving portion adjacent said distal end, said driving portion having a front face and a rear face, said front face being generally flat, a mortise disposed in said distal end of said shank, said mortise extending axially in said shank to a mortise bottom, said mortise having a cross-sectional mortise shape as taken perpendicular to said axial direction,
a carbide insert disposed in said mortise and supported by said mortise bottom, said carbide insert having a cross-sectional insert shape mating with said cross-sectional mortise shape enabling said carbide insert to be received axially into said mortise, said carbide insert having an exposed portion extending proudly from said mortise and from said distal end of said shank,
said mortise having a generally planar front wall spaced parallel from said front face of said driving portion, and said carbide insert having a generally planar load-bearing face in contact with said front wall of said mortise.

2. The traction stud of claim 1, wherein said mortise includes left and right side walls joining said front wall, said left and right side walls each having a filleted shape.

3. The traction stud of claim 2, wherein said mortise includes a rear wall joining said side walls.

4. The traction stud of claim 3, wherein said rear wall is generally planar and spaced parallel from said front wall.

5. The traction stud of claim 1, wherein said exposed portion of said carbide insert has a leading tip.

6. The traction stud of claim 5, wherein said leading tip comprises an edge.

7. The traction stud of claim 6, wherein said edge lies along said load-bearing face.

8. The traction stud of claim 5, wherein said leading tip comprises a conical point.

9. The traction stud of claim 5, wherein said exposed portion of said carbide insert has a bevel extending from said leading tip.

10. The traction stud of claim 9, wherein said bevel is generally planar.

11. The traction stud of claim 9, wherein said bevel is generally conical.

12. A snowmobile traction stud of the type affixed to a flexible endless track of a snowmobile propulsion system, said traction stud comprising:
a head,
a shank extending from said head to a distal end and defining there along an axial direction, said shank having a threaded portion adjacent said head,
said shank having a driving portion adjacent said distal end, said driving portion have a front face and a rear face, said front face being generally flat, a mortise disposed in said distal end of said shank, said mortise extending axially in said shank to a mortise bottom, said mortise having a cross-sectional mortise shape as taken perpendicular to said axial direction,
a carbide insert disposed in said mortise and supported by said mortise bottom, said carbide insert having a cross-sectional insert shape mating with said cross-sectional mortise shape enabling said carbide insert to be received axially into said mortise, said carbide insert having an exposed portion extending proudly from said mortise and from said distal end of said shank,
said mortise having a generally planar front wall spaced parallel from said front face of said driving portion, said carbide insert having a generally planar load-bearing face in contact with said front wall of said mortise, said mortise including left and right side walls joining said front wall, said left and right side walls each having a filleted shape, and
a fastener affixed to said shank, said fastener comprising a nut in operative engagement with said threaded portion of said shank.

13. The traction stud of claim 12, wherein said mortise includes a rear wall joining said side walls, said rear wall being generally planar and spaced parallel from said front wall.

14. The traction stud of claim 12, wherein said exposed portion of said carbide insert has a leading tip, said leading tip comprises an edge.

15. The traction stud of claim 14, wherein said edge lies along said load-bearing face.

16. The traction stud of claim 12, wherein said exposed portion of said carbide insert has a leading tip, said leading tip comprises a conical point.

17. The traction stud of claim 12, wherein said exposed portion of said carbide insert has a bevel extending from said leading tip, said bevel being generally planar.

18. The traction stud of claim 12, wherein said exposed portion of said carbide insert has a bevel extending from said leading tip, said bevel being generally conical.

19. A snowmobile traction stud of the type affixed to a flexible endless track of a snowmobile propulsion system, said traction stud comprising:
a head, said head having a tool-engaging feature, said head having a plurality of anti-rotation ribs,
a shank extending from said head to a distal end and defining there along an axial direction, said shank having a threaded portion adjacent said head,
said shank having a driving portion adjacent said distal end, said driving portion have a front face and a rear face, said front face being generally flat, a mortise disposed in said distal end of said shank, said mortise extending axially in said shank to a mortise bottom, said mortise having a cross-sectional mortise shape as taken perpendicular to said axial direction,
a carbide insert disposed in said mortise and supported by said mortise bottom, said carbide insert having a cross-sectional insert shape mating with said cross-sectional mortise shape enabling said carbide insert to be received axially into said mortise, said carbide insert having an exposed portion extending proudly from said mortise and from said distal end of said shank, said exposed portion of said carbide insert has a leading tip, a bevel extending from said leading tip,
a brazing compound fixedly adjoining said carbide insert to said mortise,
said mortise having a generally planar front wall spaced parallel from said front face of said driving portion, said carbide insert having a generally planar load-bearing face in contact with said front wall of said mortise, said mortise including left and right side walls joining said front wall, said left and right side walls each having a filleted shape, said mortise having a rear wall joining said side walls, said rear wall being generally planar and spaced parallel from said front wall,
said driving portion of said shank having a facet adjacent said distal end, said facet being generally aligned with said bevel of said carbide insert,
a fastener affixed to said shank, said fastener comprising a nut in operative engagement with said threaded portion of said shank.

20. The traction stud of claim 19, wherein said leading tip comprises one of an edge and a conical point.
